(19) United States
(12) Patent Application Publication
(10) Pub. No.: US 2026/0254728 A1
(43) Pub. Date: Aug. 27, 2026

(54) LEARNING DEVICE, LEARNING METHOD, AND LEARNING PROGRAM

(71) Applicant: NTT, Inc., Tokyo (JP)

(72) Inventors: Tomohiro NAGAI, Musashino-shi, Tokyo (JP); Naoto FUJIKI, Musashino-shi, Tokyo (JP)

(73) Assignee: NTT, Inc., Tokyo (JP)

(21) Appl. No.: 18/878,232

(22) PCT Filed: Jun. 23, 2022
(86) PCT No.: PCT/JP2022/025194

§ 371 Date: Dec. 23, 2024

(51) Int. Cl. H04L 41/16; H04L 9/40

(52) U.S. Cl. CPC H04L 41/16; H04L 63/1425

(57) ABSTRACT

A learning device acquires over-detection alerts in an anomaly detector. Then, the learning device clusters the acquired over-detection alerts into a plurality of clusters by using a Gaussian Mixture Model. Next, the learning device sorts, for each of the clusters, over-detection alerts belonging to the cluster in time series, and specifies a period of the sorted over-detection alerts. Then, the learning device samples the over-detection alerts from the cluster with the specified period. Thereafter, the learning device performs over-detection feedback for the anomaly detector by using the over-detection alerts sampled from each cluster.

### TECHNICAL FIELD

The present invention relates to a learning device, a learning method, and a learning program.

### BACKGROUND ART

An anomaly detection technology using unsupervised machine learning enables detection of a new type of cyberattack with high accuracy, and introduction of the technology into society is expected to be promoted. Here, in an anomaly detector using unsupervised machine learning, communication that is actually normal communication may be detected as abnormal communication and an alert (over-detection alert) may be issued. This over-detection alert makes investigation of alerts difficult and hinders operation of the anomaly detector. Therefore, in order to reduce over-detection by the anomaly detector, it is necessary to perform additional learning (over-detection feedback) for the fact that the communication for which the over-detection alert was issued is actually normal communication.

### CITATION LIST

### Patent Literature

Patent Literature 1: JP 2019-220866 A

### SUMMARY OF INVENTION

### Technical Problem

However, using a large number of over-detection alerts for over-detection feedback may cause the operation of the anomaly detector to become unstable, such as a prolonged time for learning by the anomaly detector or occurrence of overfitting. It is therefore important to select an over-detection alert used for the over-detection feedback so that the operation of the anomaly detector does not become unstable. However, in a conventional technology, it has not been studied to select an over-detection alert used for over-detection feedback so that the operation of the anomaly detector does not become unstable.

It is therefore an object of the present invention to solve the above-described problem and to select an over-detection alert used for over-detection feedback so that an operation of an anomaly detector does not become unstable.

### Solution to Problem

In order to solve the above problem, the present invention is characterized in including: an acquisition unit that acquires communication feature values of communication over-detected in an anomaly detector that detects an anomaly in communication; a clustering unit that clusters the acquired communication feature values into a plurality of clusters; a sampling unit that sorts, for each of the clusters, communication feature values belonging to the cluster in time series, specifies a period of the sorted communication feature values, and samples the communication feature values with the specified period; and a learning unit that performs additional learning for over-detection feedback on the anomaly detector by using the communication feature values sampled from each of the clusters.

### Advantageous Effects 4-4 Invention

According to the present invention, an over-detection alert used for over-detection feedback can be selected so that the operation of the anomaly detector does not become unstable.

### BRIEF DESCRIPTION OF DRAWINGS

FIG. 1 is a diagram for illustrating an overview of a learning device.

FIG. 2 is a diagram illustrating a configuration example of the learning device.

FIG. 3 is a diagram illustrating an example of feature value names constituting communication feature values associated with an over-detection alert.

FIG. 4 is a flowchart illustrating an example of a processing procedure executed by the learning device.

FIG. 5 is a diagram illustrating a result of AUC of an anomaly detector of a comparative example and a result of AUC of an anomaly detector for which over-detection feedback has been performed by the learning device.

FIG. 6 is a diagram illustrating accuracy (AUC score) and learning time of each of the anomaly detector of the comparative example and the anomaly detector for which over-detection feedback has been performed by the learning device.

FIG. 7 is a diagram illustrating a computer that executes a learning program.

### DESCRIPTION OF EMBODIMENTS

Hereinafter, a mode for carrying out the present invention (embodiment) will be described with reference to the drawings. The present invention is not limited to the embodiment described below.

### Overview

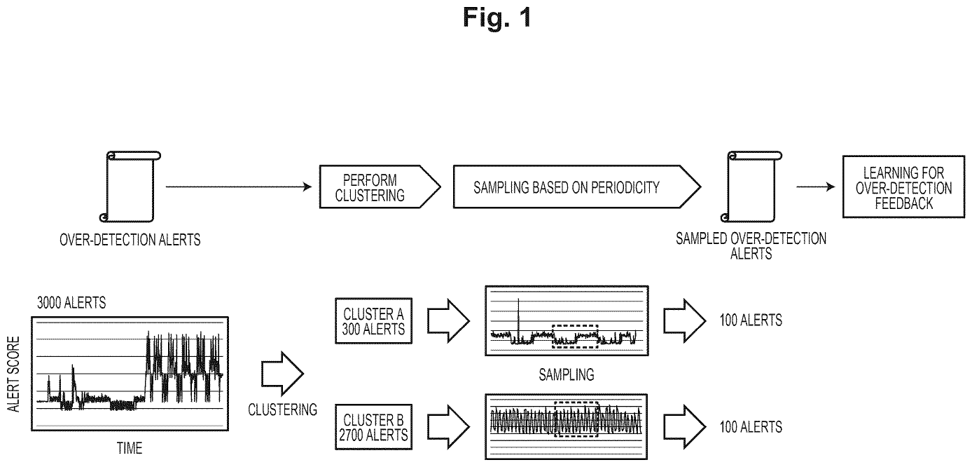

First, an overview of a learning device according to the present embodiment will be described with reference to FIG. 1. The learning device performs over-detection feedback for an anomaly detector (a device for detecting an anomaly in communication on the basis of a pre-learned machine learning model).

First, the learning device acquires over-detection alert groups of the anomaly detector. Then, the learning device clusters similar over-detection alert groups. For example, in a case where 3000 over-detection alert groups have been acquired, the learning device clusters the over-detection alert groups into Cluster A (300 groups) and Cluster B (2700 groups) on the basis of a Gaussian Mixture Model.

Next, the learning device sorts, for each cluster, the over-detection alert groups in time series, and specifies a periodicity of the over-detection alerts. Then, the learning device samples, for each cluster, the over-detection alerts at intervals of the specified period.

For example, the learning device samples 100 over-detection alerts from Cluster A and samples 100 over-detection alerts from Cluster B. Then, the learning device uses the sampled over-detection alert groups to perform learning for over-detection feedback for the anomaly detector.

In this manner, the learning device clusters over-detection alert groups, samples the over-detection alerts on the basis of the periodicity of the over-detection alerts in each cluster, and performs over-detection feedback. Thus, the learning device can use over-detection alerts that are exhaustive and balanced to perform over-detection feedback for the anomaly detector. As a result, the learning device can perform over-detection feedback in a short time without reduction in accuracy of the anomaly detector.

### Configuration Example

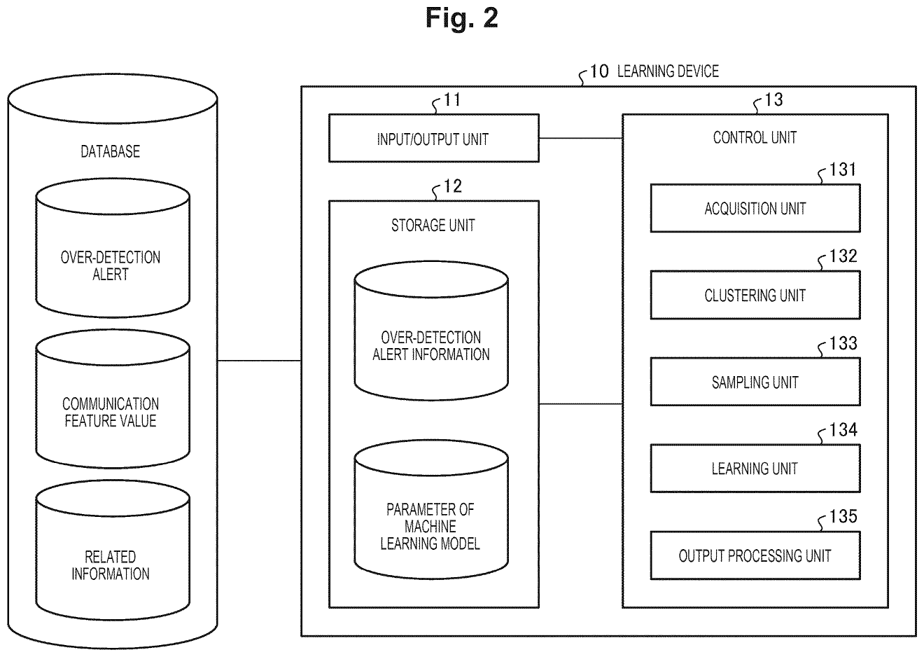

Next, a configuration example of a learning device 10 will be described with reference to FIG. 2. The learning device 10 includes an input/output unit 11, a storage unit 12, and a control unit 13.

### Input/Output Unit

The input/output unit 11 serves as an interface for the learning device 10 to receive an input of and output various types of information. For example, the input/output unit 11 receives, from an external database, inputs of an over-detection alert, a communication feature value associated with the over-detection alert, and information related to the communication feature value (e.g., ID of the communication feature value and reception time). In addition, the input/output unit 11 outputs a result of processing by the control unit 13. For example, the input/output unit 11 outputs the number of communication feature values used for over-detection feedback in the control unit 13, the IDs of the communication feature values, and the like.

### Storage Unit

The storage unit 12 stores various types of information and programs used when the control unit 13 operates, and various types of information obtained as a result of the operation of the control unit 13. Here, the storage unit 12 is, for example, a semiconductor memory element such as a random access memory (RAM) or a flash memory, or a storage device such as a hard disk or an optical disk.

The storage unit 12 stores, for example, an over-detection alert, a communication feature value associated with the over-detection alert, and information related to the communication feature value (these are collectively referred to as over-detection alert information) input via the input/output unit 11. In addition, the storage unit 12 stores parameters of the machine learning model used by the anomaly detector for which the over-detection feedback is to be performed. This machine learning model is, for example, a model that determines whether communication that has been input is abnormal and outputs a result of the determination. The parameters of the machine learning model are updated by the control unit 13 executing learning for over-detection feedback.

### Control Unit

The control unit 13 controls the entire learning device 10. The control unit 13 includes an acquisition unit 131, a clustering unit 132, a sampling unit 133, a learning unit 134, and an output processing unit 135. The function of each unit of the control unit 13 is implemented by a CPU equipped in the learning device 10 executing a program stored in the storage unit 12.

### Acquisition Unit

The acquisition unit 131 acquires an over-detection alert group of the anomaly detector. For example, the acquisition unit 131 acquires, from an external database, an over-detection alert group issued from the same device (anomaly detector). The device is identified by using, for example, a source IP address or a source MAC address of the over-detection alert.

In addition, the acquisition unit 131 acquires, from the database, communication feature values associated with the over-detection alert and the information related to the communication feature values (e.g., IDs of the communication feature values and reception times). The above-described communication feature values are feature values of traffic communication data for which an over-detection alert is to be issued.

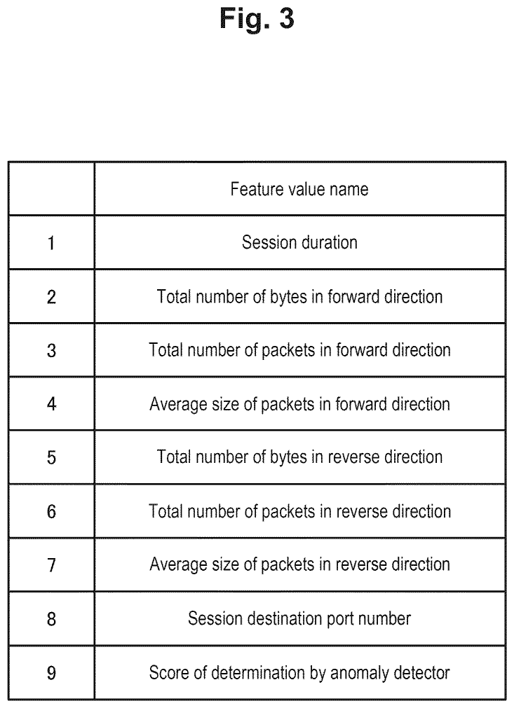

The communication feature values include, for example, feature values illustrated in FIG. 3. That is, the communication feature values include feature values such as a session duration of communication, a total number of bytes in a forward direction, a total number of packets in a forward direction, an average size of packets in a forward direction, a total number of bytes in a reverse direction, a total number of packets in a reverse direction, an average size of packets in a reverse direction, a session destination port number, and a score of determination by the anomaly detector.

### Clustering Unit

The description will now return to FIG. 2. The clustering unit 132 clusters the communication feature values associated with the over-detection alert acquired by the acquisition unit 131 into a plurality of clusters.

For example, the clustering unit 132 uses the Gaussian Mixture Model to cluster the communication feature values acquired by the acquisition unit 131 so that similar communication feature values belong to the same cluster.

At this time, for example, in order to determine the number of clusters, the clustering unit 132 first performs clustering so as to generate 1 to 10 clusters. Then, the clustering unit 132 determines the most appropriate number of clusters from 1 to 10 on the basis of the Bayesian information criterion. Note that a variance type, which is a parameter of the Gaussian mixture model described above, is the same for each cluster.

The method of clustering is not limited to the method using the Gaussian mixture model described above as long as similar data (communication feature values) belongs to each cluster and the data in the cluster is balanced as much as possible.

### Sampling Unit

The sampling unit 133 samples the communication feature values from each cluster. For example, the sampling unit 133 sorts, for each cluster, communication feature value groups belonging to the cluster in time series. Then, the sampling unit 133 specifies, for each cluster, the period of the communication feature value groups belonging to the cluster, and samples the communication feature values with the specified period. In a case where the period of the communication feature value groups belonging to the cluster cannot be specified, the sampling unit 133 randomly samples the communication feature values from the cluster.

As a specific example, the sampling unit 133 acquires, for each cluster, data (communication feature values) belonging to the cluster and its related information. Then, the sampling unit 133 sorts the communication feature values belonging to each cluster in time series on the basis of the reception time indicated by the acquired related information.

Next, the sampling unit 133 calculates an autocorrelation coefficient from the sorted communication feature values in the cluster. Lags as parameters of the autocorrelation coefficient are in a range from 1 to the number of pieces of data belonging to the cluster. Then, the sampling unit 133 specifies, among the lugs, a lug in which the autocorrelation coefficient becomes the maximum value, as the period of the data of the cluster (the number of pieces of period data). Thereafter, the sampling unit 133 samples a communication feature value for each specified period from the sorted communication feature values in the cluster. The sampling unit 133 executes the processing described above on each cluster.

For example, the sampling unit 133 receives an input of a sampling number N of each cluster from a user of the learning device 10. Then, the sampling unit 133 samples, for each cluster, the communication feature values for each period (the number of pieces of period data) in order from the communication feature value at the oldest time until the sampling number N is satisfied. Then, the sampling unit 133 records the IDs of the sampled communication feature values in a learning list.

In a case where the maximum value of the autocorrelation coefficient of the communication feature values in the cluster is less than a predetermined threshold, the sampling unit 133 determines that the period of the communication feature values of the cluster cannot be specified (there is no periodicity). Then, the sampling unit 133 randomly samples N data communication feature values from the cluster. Then, the sampling unit 133 records the IDs of the randomly sampled communication feature values in the learning list.

The learning unit 134 uses the communication feature values sampled by the sampling unit 133 to perform learning for over-detection feedback for the anomaly detector.

For example, the learning unit 134 acquires communication feature values associated with an over-detection alert from the storage unit 12 on the basis of the IDs of the communication feature values indicated in the learning list described above. Then, using the acquired communication feature values as learning data of normal communication, the learning unit 134 performs additional learning of the machine learning model used by the anomaly detector and updates the parameters of the machine learning model.

The output processing unit 135 outputs a result of processing by the control unit 13 via the input/output unit 11. For example, the output processing unit 135 outputs the number of communication feature values used for over-detection feedback for the anomaly detector, the IDs of the communication feature values, the time required for the over-detection feedback, and the like.

The learning device 10 as described above can perform over-detection feedback in a short time without reduction in accuracy of the anomaly detector. As a result, the learning device 10 can stably operate the anomaly detector.

### Example of Processing Procedure

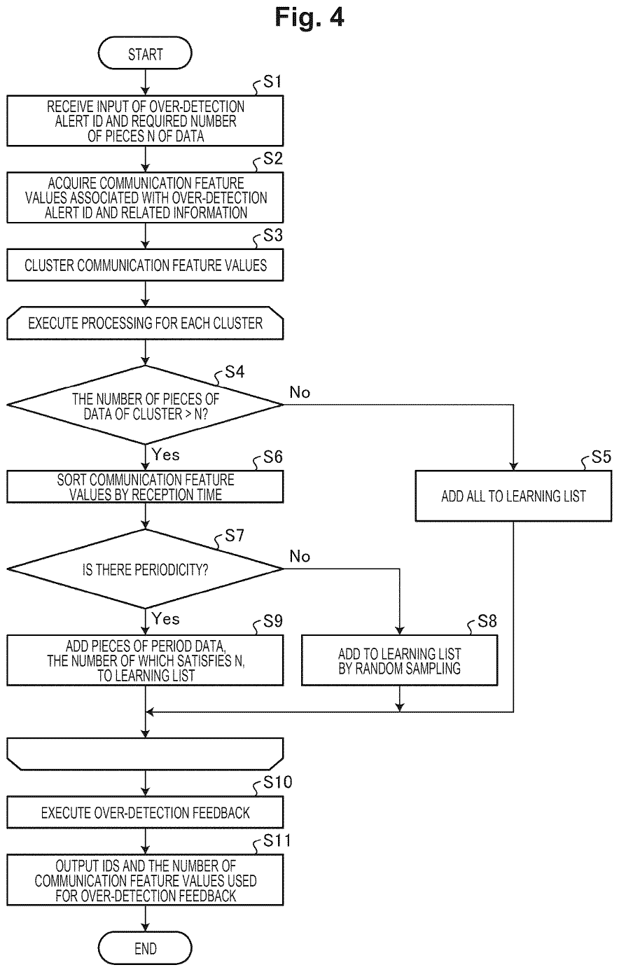

Next, an example of a processing procedure of the learning device 10 will be described with reference to FIG. 4. For example, the learning device 10 receives an input of an over-detection alert ID and the required number of pieces N of data (the number of pieces of sampling data per cluster) (S1). Thereafter, the acquisition unit 131 acquires, from the database, communication feature values associated with the over-detection alert ID received in S1 and related information (e. g., reception times of the communication feature values) (S2). Then, the clustering unit 132 clusters the communication feature values acquired in S2 (S3).

Thereafter, the sampling unit 133 executes processing of S4 to S9 described below for each cluster generated by the clustering in S3. First, the sampling unit 133 determines whether the number of pieces of data (communication feature values) of the cluster generated in S3 exceeds N (S4), and if it is determined that the number exceeds N (Yes in S4), the communication feature values in the cluster are sorted by reception time (S6).

After S6, the sampling unit 133 determines whether the communication feature values in the cluster have a periodicity (S7), and if it is determined that the communication feature values have a periodicity (Yes in S7), pieces of period data, the number of which satisfies N described above, are added to a learning list (S9). For example, the sampling unit 133 specifies the period of the sorted communication feature value groups in the cluster, and then samples the communication feature values for each specified period. Then, the sampling unit 133 adds the IDs of the sampled communication feature values to the learning list.

If it is determined in S4 that the number of pieces of data of the cluster generated in S3 does not exceed N (No in S4), the sampling unit 133 adds the IDs of all the communication feature values of the cluster to the learning list (S5: add all to learning list). Thereafter, the processing proceeds to the next cluster.

In S7, in a case where the sampling unit 133 determines that there is no periodicity in the communication feature values in the cluster (No in S7), the sampling unit adds, to the learning list, the IDs of the communication feature values randomly sampled from the communication feature values of the cluster (S8: add to learning list by random sampling). Thereafter, the processing proceeds to the next cluster.

After the sampling unit 133 has executed the processing of S4 to S9 on all the clusters, the learning unit 134 executes over-detection feedback on the anomaly detector by using the communication feature values of the IDs on the learning list (S10). For example, the learning unit 134 uses the communication feature values of the IDs on the learning list to perform additional learning for over-detection feedback on the machine learning model used by the anomaly detector. Thereafter, the output processing unit 135 outputs the IDs, the number, and the like of the communication feature values used for the over-detection feedback (S11).

The learning device 10 executes the processing described above, and thus it is possible to perform over-detection feedback in a short time without reduction in accuracy of the anomaly detector. As a result, the learning device 10 can stably operate the anomaly detector.

Note that the learning device 10 may perform only sampling of the communication feature values used for over-detection feedback, and the over-detection feedback using the communication feature values may be executed by another device. In this case, the learning device 10 outputs the sampled communication feature values to the device. Then, the device uses the communication feature values output from the learning device 10 to perform over-detection feedback.

The learning device 10 may further include a detection unit that uses the machine learning model after the over-detection feedback to detect an anomaly in Communication that has been input.

### Evaluation Result

Next, a result of an experiment for evaluating the accuracy and learning time of an anomaly detector (machine learning model) for which over-detection feedback has been performed by the learning device 10 of the present embodiment will be described.

### Experimental Conditions

Experimental conditions are as follows.
Initial learning of the anomaly detector has been sufficiently performed.
A new communication is input to the anomaly detector, and an over-detection alert is generated. The new communication to be input is communication of two types of communication protocols.
A comparative example is an anomaly detector for which over-detection feedback has been performed using over-detection alerts (2000 alerts).
The learning device 10 of the present embodiment has performed over-detection feedback for the anomaly detector using over-detection alerts (600 alerts) sampled from the over-detection alerts (2000 alerts).
Evaluation data includes data of normal communication (350 pieces) and data of abnormal communication (350 pieces). This evaluation data is used for evaluation of the accuracy (AUC score) and the learning time for each of the anomaly detector of the comparative example and the anomaly detector for which over-detection feedback has been performed by the learning device 10 of the present embodiment.
The machine used for the anomaly detector is a terminal on Vmware Esxi, and has a CPU of 16 vCPU and a memory of 32 GB.

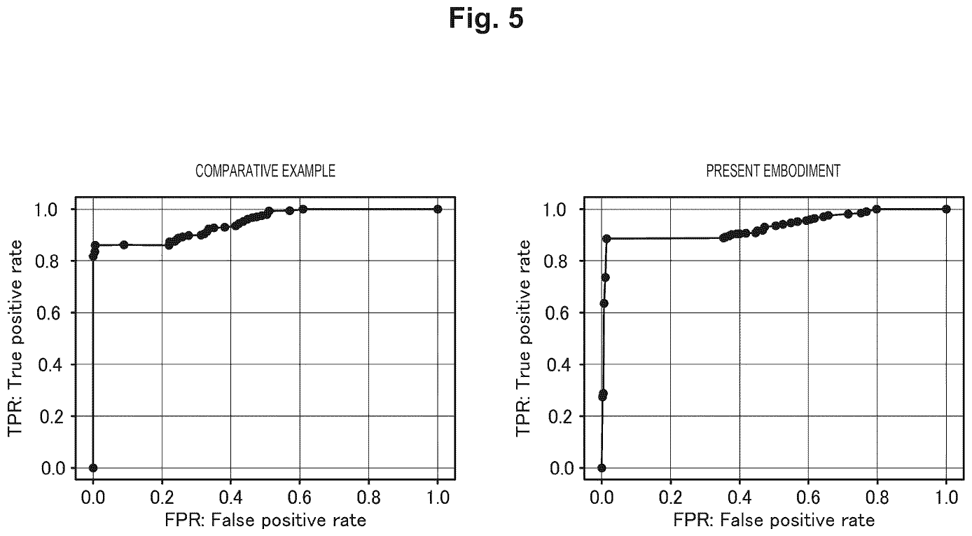

The results of the AUC of each of the anomaly detector of the comparative example and the anomaly detector for which over-detection feedback has been performed by the learning device 10 of the present embodiment are as illustrated in FIG. 5.

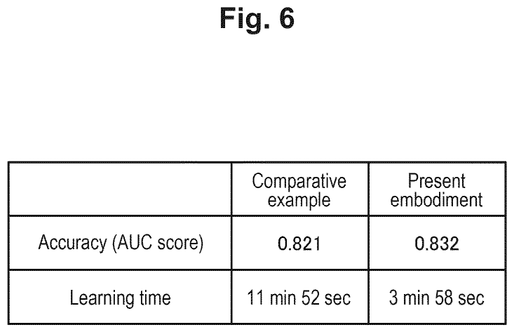

As illustrated in FIG. 6, the anomaly detector for which over-detection feedback has been performed by the learning device 10 of the present embodiment had an accuracy (AUC score) higher by 0.011 than the anomaly detector of the comparative example. In addition, according to the learning device 10 of the present embodiment, it has been confirmed that the time required for over-detection feedback (learning time) is shortened by 7 min 54 sec as compared with the comparative example. That is, according to the learning device 10 of the present embodiment, it has been confirmed that over-detection feedback can be performed at high speed without reduction in accuracy of the anomaly detector.

### System Configuration and Others

In addition, each of components of the units illustrated in the drawings is functionally conceptual and does not necessarily need to be physically configured as illustrated in the drawings. That is, specific forms of distribution and integration of devices are not limited to the illustrated forms, and all or some of the devices can be functionally or physically distributed or integrated in any unit according to various loads, usage conditions, and the like. Further, all or some of the processing functions performed in each device can be implemented by a CPU and a program executed by the CPU, or can be implemented as hardware by wired logic.

Of the pieces of processing described in the above-described embodiment, all or some of the pieces of processing described as being automatically performed may be manually performed, or all or some of the pieces of processing described as being manually performed may be automatically performed by a known method. The processing procedures, control procedures, specific names, and information including various types of data and parameters described above in the specification and drawings can be optionally changed unless otherwise mentioned.

### Program

The foregoing learning device 10 can be implemented by installing a program (learning program) in a desired computer as package software or online software. For example, an information processing device can be caused to function as the learning device 10 by causing the information processing device to execute the above program. Here, the information processing device also includes mobile communication terminals such as a smartphone, a mobile phone, and a personal handyphone system (PHS) and terminals such as a personal digital assistant (PDA).

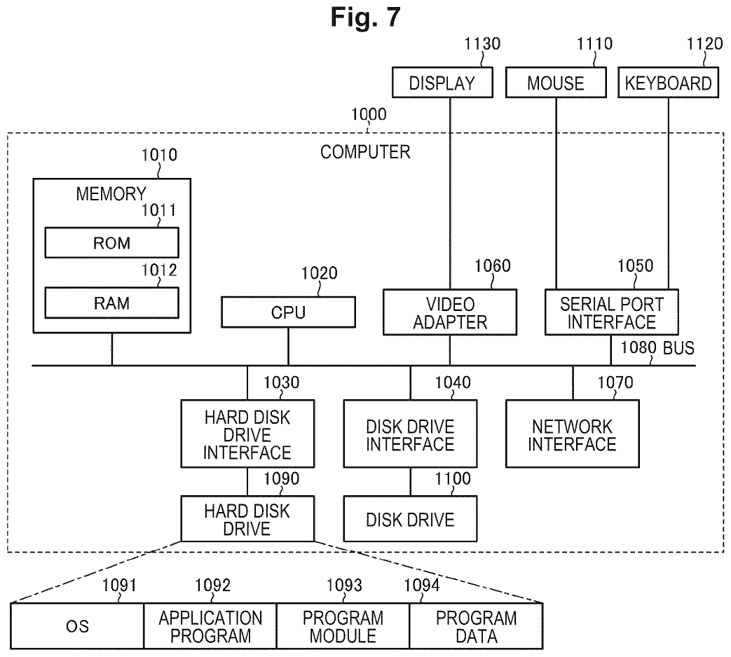

FIG. 7 is a diagram illustrating an example of a computer that executes the learning program. A computer 1000 includes, for example, a memory 1010 and a CPU 1020.

The computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each piece of processing executed by the learning device 10 is implemented as the program module 1093 in which codes executable by the computer are described. The program module 1093 is stored in, for example, the hard disk drive 1090. For example, the program module 1093 for executing processing similar to that of the functional configuration in the learning device 10 is stored in the hard disk drive 1090. The hard disk drive 1090 may be replaced with a solid state drive (SSD).

Data to be used in the processing of the above embodiment is stored as the program data 1094 in, for example, the memory 1010 or the hard disk drive 1090. The CPU 1020 reads the program module 1093 and the program data 1094 stored in the memory 1010 and the hard disk drive 1090 into the RAM 1012 as necessary and executes the program module 1093 and the program data 1094.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Learning device
11 Input/output unit
12 Storage unit
13 Control unit
131 Acquisition unit
132 Clustering unit
133 Sampling unit
134 Learning unit
135 Output processing unit

1. A learning device comprising:
a memory; and
a processor coupled to the memory and programmed to execute a process comprising:
acquiring communication feature values of communication over-detected in an anomaly detector that detects an anomaly in communication;
clustering the acquired communication feature values into a plurality of clusters;
sorting, for each of the clusters, communication feature values belonging to the cluster in time series, specifying a period of the sorted communication feature values, and sampling the communication feature values with the specified period; and
performing additional learning for over-detection feedback on the anomaly detector by using the communication feature values sampled from each of the clusters.

2. The learning device according to claim 1, wherein
the clustering is configured to:
using a Gaussian Mixture Model to cluster the communication feature values into a plurality of clusters.

3. The learning device according to claim 1, wherein
the sampling is configured to:
randomly sampling the communication feature values from the communication feature values belonging to the cluster in a case where it has not been possible to specify the period of the communication feature values belonging to the cluster.

4. The learning device according to claim 1, wherein the sampling is configured to:
calculating an autocorrelation coefficient of each of the sorted communication feature values, and specifying the period of the communication feature values on the basis of the calculated autocorrelation coefficient.

5. The learning device according to claim 1, further comprising:
detecting an anomaly in communication that has been input, by using the anomaly detector after additional learning.

6. A learning method executed by a learning device, the learning method comprising:
a step of acquiring communication feature values of communication over-detected in an anomaly detector that detects an anomaly in communication;
a step of clustering the acquired communication feature values into a plurality of clusters;
a step of sorting, for each of the clusters, communication feature values belonging to the cluster in time series, specifying a period of the sorted communication feature values, and sampling the communication feature values with the specified period; and
a step of performing additional learning for over-detection feedback on the anomaly detector by using the communication feature values sampled from each of the clusters.

7. A non-transitory computer readable storage medium having stored therein a learning program that causes a computer to execute a process comprising the steps of:
a step of acquiring communication feature values of communication over-detected in an anomaly detector that detects an anomaly in communication;
a step of clustering the acquired communication feature values into a plurality of clusters;
a step of sorting, for each of the clusters, communication feature values belonging to the cluster in time series, specifying a period of the sorted communication feature values, and sampling the communication feature values with the specified period; and
a step of performing additional learning for over-detection feedback on the anomaly detector by using the communication feature values sampled from each of the clusters.
